(19) United States
(12) Patent Application Publication
(10) Pub. No.: US 2006/0030253 A1
(43) Pub. Date: Feb. 9, 2006

(54) Inside and outside air change-over control unit for vehicle use

(75) Inventors: Norio Asai, Nukata-gun (JP); Yuuji Honda, Okazaki-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 11/151,675

(22) Filed: Jun. 13, 2005

(30) Foreign Application Priority Data
Jun. 15, 2004 (JP) 2004-176850

(51) Int. Cl. B60H 1/00

(52) U.S. Cl. 454/75

(57) ABSTRACT

At the time of the inside air mode, the concentration of CO₂ in the vehicle passenger compartment is calculated (S80). When the calculated value of the concentration of CO₂ in the vehicle passenger compartment exceeds a predetermined value, the inside and outside change-over door is changed over to the outside air mode (S90, S20).

### BACKGROUND OF THE INVENTION

1. Field of the Invention

The present invention relates to an inside and outside air change-over control unit of an air conditioner for vehicle use.

2. Description of the Related Art

An inside and outside air change-over control unit of a conventional air conditioner for vehicle use includes: a timer circuit for measuring the inside air mode time when the vehicle speed is lower than the setting vehicle speed; and a vehicle speed sensor for detecting the vehicle speed, wherein the introduction of the inside and outside air is automatically changed over according to output signals sent from the timer circuit and the vehicle speed sensor. This conventional inside and outside air change-over control unit is disclosed in the official gazette of JP-A-61-37521.

According to this prior art, when the vehicle is running at a speed lower than the setting vehicle speed or when the vehicle is started, the mode is automatically changed over to the inside air mode. When the vehicle is running at a speed higher than the setting vehicle speed or when the vehicle is decelerated, the mode is automatically changed over to the outside air mode. Further, when the inside air mode time in the case where the vehicle is running at a speed lower than the setting speed is longer than a predetermined period of time or when the vehicle stopping time is longer than a predetermined period of time, the mode is automatically changed over to the outside air mode.

However, in the above prior art, the inside and outside air mode is automatically changed over only by the timer output and the vehicle speed sensor output. In other words, in the above prior art, the inside and outside air mode is not automatically changed over according to the concentration of CO₂ (carbon dioxide) in the vehicle passenger compartment.

### SUMMARY OF THE INVENTION

In view of the above points, it is an object of the present invention to provide an inside and outside air change-over control unit capable of automatically changing over the inside and outside air mode according to the concentration of CO₂ (carbon dioxide) in the vehicle passenger compartment.

In order to accomplish the above object, according to a first aspect of the present invention, there is provided an inside and outside air change-over control unit for vehicle use comprising:

an inside and outside air change-over means (6) for changing over between an inside air mode to introduce the inside air from a vehicle passenger compartment and an outside air mode to introduce the outside air from the outside of the vehicle passenger compartment, the introduced inside air or outside air being introduced to a blowing port to the vehicle passenger compartment; and

a control unit (29) for controlling an operational position of the inside and outside air change-over means (6),

the control unit (29) including:

a calculation means (S80) for calculating the concentration of CO₂ in the vehicle passenger compartment at the time of the inside air mode; and

a change-over control means (S20, S90) for changing over the inside and outside air change-over means (6) to the outside air mode when the calculated concentration of CO₂ in the vehicle passenger compartment exceeds a predetermined value, wherein

the calculation means (S80) calculates the concentration of CO₂ in the vehicle passenger compartment at the time of the inside air mode according to the elapsed time, which is a variable, after the change-over to the inside air mode and also according to the amount of ventilated air in the vehicle passenger compartment, which is a variable, generated by dynamic pressure of vehicle running at the time of the inside air mode.

According to the present invention, the concentration of CO₂ in the vehicle passenger compartment is calculated at the time of the inside air mode, and an increase in the concentration of CO₂ is judged and the mode can be automatically changed over to the outside air mode. Accordingly, it is possible to avoid the generation of an uncomfortable state in which the concentration of CO₂ in the vehicle passenger compartment is increased, so that the passenger can drive the vehicle in a comfortable state.

Further, a sensor for detecting CO₂ in the vehicle passenger compartment is not provided but the calculating means (S80) for calculating the concentration of CO₂ in the vehicle passenger compartment is provided so that the inside and outside air can be automatically changed over. Therefore, it is unnecessary to add a special sensor such as a sensor for detecting CO₂ in the vehicle passenger compartment. Therefore, it is easy to put the present invention into practical use.

In the case where the concentration of CO₂ in the vehicle passenger compartment is not increased to a value not less than a predetermined value, the inside air mode is maintained. Therefore, air conditioning can be carried out while the state of the inside air mode is maintained longer. In this case, at the time of the inside air mode, the air in the vehicle passenger compartment, the temperature of which has been adjusted, is recirculated so that the vehicle passenger compartment can be air-conditioned. Accordingly, not only the heat load of air conditioning can be reduced but also the polluted outside air can be prevented from flowing into the vehicle passenger compartment and the air in the vehicle passenger compartment can be prevented from becoming excessively dry in winter.

According to a second aspect of the present invention, the calculation means (S80) calculates the concentration of CO₂ in the vehicle passenger compartment at the time of the inside air mode according to the elements including the amount of CO₂ generated by a passenger at the time of the inside air mode, an elapsed time after the change-over to the inside air mode, the amount of ventilated air generated by dynamic pressure of vehicle running at the time of the inside air mode and a volume inside the vehicle passenger compartment.

According to a third aspect of the present invention, the amount of ventilated air in the vehicle passenger compartment is calculated from an information value relating to a vehicle speed, which is a variable, and the calculation means (S80) calculates the concentration of CO₂ in the vehicle passenger compartment at the time of the inside air mode when the elapsed time after the change-over to the inside air mode and the amount of ventilated air in the vehicle passenger compartment are used as variables and fixed values, which have been previously set, are used for the other elements.

According to a fourth aspect of the present invention, the amount of ventilated air in the vehicle passenger compartment is calculated from the information value relating to the vehicle speed, including variables, the amount of CO₂ generated by passengers at the time of the inside air mode is calculated from the number of passengers, which is a variable, and the calculating means (S80) only includes the variables of the elapsed time after the change-over to the inside air mode, the amount of ventilated air in the vehicle passenger compartment and the amount of CO₂ generated by passengers at the time of the inside air mode and also includes the previously determined fixed values of the other elements so as to calculate the concentration of CO₂ in the vehicle passenger compartment at the time of the inside air mode.

Due to the foregoing, it is possible to calculate the amount of CO₂ while consideration is being given to the number of the actual passengers. Therefore, the accuracy of calculating the concentration of CO₂ in the vehicle passenger compartment can be further enhanced.

According to a fifth aspect of the present invention, the inside and outside air change-over control unit for vehicle use, further comprises a sensor (30) for detecting an information value relating to the vehicle speed, wherein a value obtained after the detection value of the sensor (30) has been smoothed is used for calculating the amount of ventilated air in the vehicle passenger compartment as the information value relating to the vehicle speed.

Due to the foregoing, an influence given by a sudden change in the vehicle speed can be eliminated, and the inside and outside air change-over control can be stably executed.

According to a sixth aspect of the present invention, the information value relating to the vehicle speed is a vehicle speed or an engine speed of the vehicle.

According to a seventh aspect of the present invention, when the information value relating to the vehicle speed is not less than a predetermined value, the inside air mode is maintained.

In this connection, in the case where the vehicle is running at high speed not less than a predetermined value, even when the mode is the inside air mode, the amount of air in the vehicle passenger compartment to be ventilated by the dynamic pressure of vehicle running is increased. Therefore, the concentration of CO₂ in the vehicle passenger compartment can be maintained low. In this seventh aspect, attention is given to this point and the inside air mode is maintained when the vehicle is running at high speed. Therefore, when the state, in which the vehicle is running at high speed, is just judged, the state of the inside air mode can be positively maintained.

In this connection, “the information value relating to the vehicle speed” includes an information value such as a vehicle engine speed, which changes in a predetermined correlation with the vehicle speed, other than the vehicle speed.

According to an eighth aspect of the present invention, when the information value relating to the vehicle speed is not less than a predetermined value, the calculation of the concentration of CO₂ in the vehicle passenger compartment conducted by the calculation means is stopped and the inside air mode is maintained.

According to a ninth aspect of the present invention, the inside and outside air change-over control unit for vehicle use further comprises a fan and a heat exchanger arranged between the inside and outside air change-over means (6) and the blowing port, wherein a flow of air, the temperature of which is adjusted when it has passed through the heat exchanger (9, 15), is blown into the vehicle passenger compartment via the blowing port.

According to a tenth aspect of the present invention, the inside and outside air change-over control unit for vehicle use further comprises an automatic switch for outputting an operational signal to automatically control the inside and outside air change-over means into the control unit, the control unit (29) including a means in which when the automatic switch is turned on, the inside and outside air change-over means is changed over to the outside air mode, it is judged whether or not the elapsed time after the change-over to the outside air mode has passed through a predetermined time, the outside air mode is continued when the elapsed time after the change-over to the outside air mode does not exceed a predetermined period of time, and the control for changing over the outside air mode to the inside air mode is executed as an initial mode when the elapsed time has reached a predetermined period of time.

Due to the foregoing, while consideration is being given to a case in which the inside air mode is manually set before the automatic controlling operation is started, ventilation in the vehicle passenger compartment, which is the initial setting, can be conducted first. Therefore, by the calculated concentration of CO₂ in the vehicle passenger compartment, the inside and outside air change-over means (6) can be precisely changed over to the outside air mode.

According to an eleventh aspect of the present invention, the inside and outside air change-over control unit for vehicle use further comprises: a timer means for measuring the elapsed time of the inside air mode after the automatic switch has been turned on, arranged in the control unit; and a means for judging whether or not the information value relating to the vehicle speed is not less than a predetermined value, wherein when the judging means judges that the information value is an information value relating to the vehicle speed not less than the predetermined value, the measurement of time by the timer means is reset, and when the information value relating to the vehicle speed is lower than the predetermined value, the calculation means calculates the concentration of CO₂ at the time of the inside air mode according to the elapsed time measured by the timer means and also according to the amount of ventilated air in the vehicle passenger compartment, which is a variable, generated by dynamic pressure of running vehicle at the time of the inside air mode.

Due to the foregoing, in the case where the vehicle speed is high and it is unnecessary to introduce the outside air into the vehicle passenger compartment, the inside air mode can be continued. As the inside air mode can be maintained in this way, it is possible to increase a ratio of the inside air mode when air conditioning is conducted.

According to a twelfth aspect of the present invention, the calculation means calculates the concentration of CO₂ in the vehicle passenger compartment at the time of inside air mode in such a manner that while consideration is being given to the amount of CO₂ generated by passengers, the amount of CO₂ generated by the passengers is found from the product of the amount of CO₂ generated by one passenger and the number of the passengers, and the amount of ventilated air in the vehicle passenger compartment is found according to the information value relating to the vehicle speed.

According to a thirteenth aspect of the present invention, the amount of ventilated air in the vehicle passenger compartment is found by the product of the amount of ventilated air per unit vehicle speed, which is set for each vehicle, and the vehicle speed.

According to a fourteenth aspect of the present invention, the concentration of CO₂ in the vehicle passenger compartment at the point of time when the predetermined period of time has passed after the change-over to the inside air mode is calculated as a function, the variables of which are at least the amount of ventilated air per unit vehicle speed at the time of the inside air mode, the vehicle speed of the vehicle, the elapsed time after the change-over to the inside air mode, the volume in the vehicle passenger compartment, the amount of generated CO₂ per one passenger and unit time, the number of passengers and the concentration of CO₂ of the outside air.

According to a fifteenth aspect of the present invention, the amount of ventilated air per unit vehicle speed at the time of the inside air mode, the volume in the vehicle passenger compartment, the amount of generated CO₂ per one passenger and unit time, the number of passengers and the concentration of CO₂ of the outside air are the fixed values which have been previously set, and the vehicle speed of the vehicle and the elapsed time after the change-over to the inside air mode include variables.

According to a sixteenth aspect of the present invention, a predetermined value is set as a value of the level at which a passenger in the vehicle passenger compartment feels uncomfortable due to an increase in the concentration of CO₂,

the inside and outside air change-over control unit for vehicle use further comprises a means for judging whether or not the concentration of CO₂ in the vehicle passenger compartment at the time of the inside air mode calculated after the change-over to the inside air mode is not less than the above predetermined value, and when the concentration of CO₂ in the vehicle passenger compartment is lower than the predetermined value, the state of inside air mode is maintained, and when the concentration of CO₂ in the vehicle passenger compartment is not less than the predetermined value, the inside air mode is changed over to the outside air mode, and the outside air mode is continued until a predetermined condition is established.

Due to the foregoing, the amount of air to be ventilated in the vehicle passenger compartment can be rapidly increased as compared with the time of the inside air mode. Therefore, the concentration of CO₂ in the vehicle passenger compartment can be quickly decreased. As the outside air mode is continued until a predetermined condition is satisfied, the concentration of CO₂ in the vehicle passenger compartment can be sufficiently lowered to a comfortable level. Accordingly, passengers can comfortably ride the vehicle without feeling uncomfortable due to an increase in the concentration of CO₂ in the vehicle passenger compartment. As the inside air mode is maintained when the concentration of CO₂ in the vehicle passenger compartment is lower than a predetermined value, it is possible to increase a ratio of the inside air mode at the time of operation of air conditioning.

According to a seventeenth aspect of the present invention, the establishment of the predetermined condition is that a predetermined period of time has passed after the change-over to the outside air mode or that the concentration of CO₂ in the vehicle passenger compartment calculated after the change-over to the outside air mode has decreased to a predetermined level, and the outside air mode is changed over to the inside air mode after the establishment of the predetermined condition.

According to an eighteenth aspect of the present invention, the concentration of CO₂ in the vehicle passenger compartment calculated after the change-over to the outside air mode is calculated as a function, the variables of which are at least the vehicle speed of the vehicle and the elapsed time after the change-over to the outside air mode.

According to a nineteenth aspect of the present invention, the concentration of CO₂ in the vehicle passenger compartment calculated after the change-over to the outside air mode is calculated as a function, the variables of which are the amount of ventilated air per unit vehicle speed at the time of the outside air mode, the vehicle speed of the vehicle, the elapsed time after the change-over to the outside air mode, the volume in the vehicle passenger compartment, the amount of generated CO₂ per one passenger and unit time, the number of passengers and the concentration of CO₂ of the outside air.

According to a twentieth aspect of the present invention, the amount of ventilated air per unit vehicle speed at the time of the outside air mode, the volume in the vehicle passenger compartment, the amount of generated CO₂ per one passenger and unit time, the number of passengers and the concentration of CO₂ of the outside air are the fixed value which have been previously set, and the vehicle speed of the vehicle and the elapsed time after the change-over to the outside air mode include variables.

Incidentally, the reference numerals in parentheses, to denote the above means, are intended to show the relationship of the specific means which will be described later in an embodiment of the invention.

The present invention may be more fully understood from the description of preferred embodiments of the invention set forth below, together with the accompanying drawings.

### BRIEF DESCRIPTION OF THE DRAWINGS

In the drawings:

FIG. 1 is a view showing an outline of the entire system of the first embodiment of the present invention; and

FIG. 2 is a flow chart showing the inside and outside air change-over control in the first embodiment of the present invention.

### DESCRIPTION OF PREFERRED EMBODIMENTS

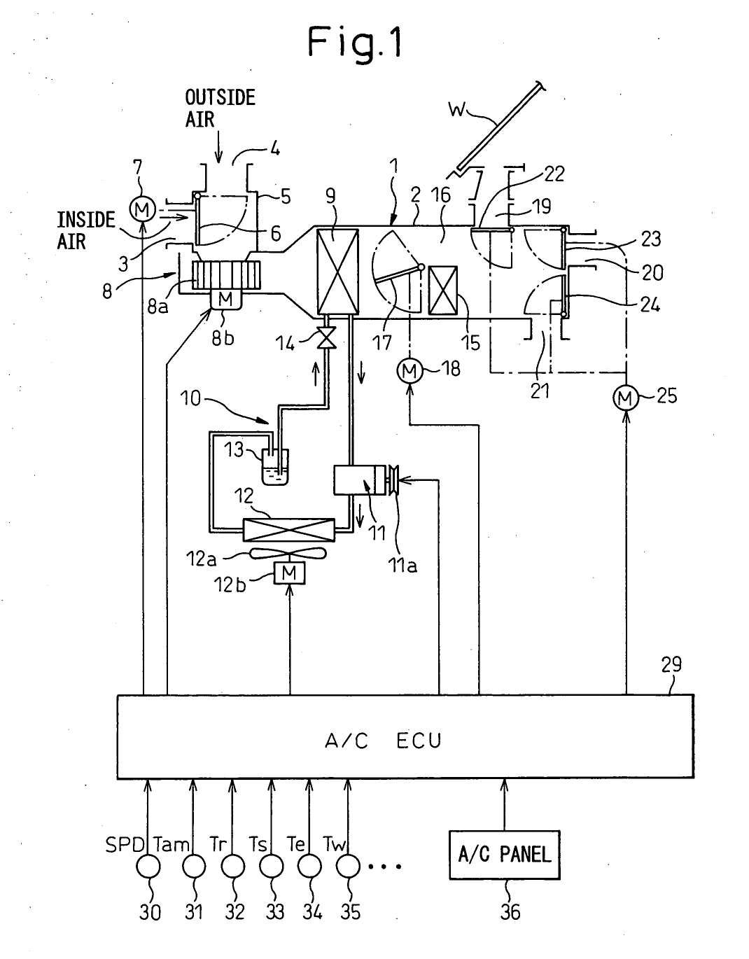

First of all, an explanation will be given of the first embodiment. FIG. 1 is an overall arrangement view of the first embodiment. The air conditioner for vehicle use shown in FIG. 1 includes an interior air conditioning unit 1 arranged inside the instrument panel (not shown) provided in the front portion of the vehicle passenger compartment. This interior air conditioning unit 1 includes a case 2. An air passage, in which a flow of air is blown toward the vehicle passenger compartment, is composed in this case 2.

In the most upstream portion of the air passage in this case 2, an inside and outside air change-over box 5, which has an inside air introducing port 3 and an outside air introducing port 4, is arranged. In this inside and outside air change-over box 5, the inside and outside air change-over door 6, which is an inside and outside air change-over means, is pivotally arranged.

This inside and outside air change-over door 6 is driven by the servo motor 7 and is changed over between the inside air mode, in which the inside air (the air inside the vehicle passenger compartment) is introduced from the inside air introducing port 3, and the outside air mode, in which the outside air (the air outside the vehicle passenger compartment) is introduced from the outside air introducing port 4.

The electrically-driven fan 8 for generating a flow of air directed to the vehicle passenger compartment is arranged on the downstream side of the inside and outside air change-over box 5. This fan 8 is driven in such a manner that the centrifugal fan 8a is driven by the electric motor 8b. On the downstream side of the fan 8, the evaporator 9 is arranged which cools a flow of air flowing in the case 2. This evaporator 9 is a heat exchanger used for cooling a flow of air sent from the fan 8. Therefore, this evaporator 9 is one of the components composing the refrigerating cycle unit 10.

In this connection, the refrigerating cycle unit 10 is an well-known refrigerating cycle unit in which the refrigerant is circulated from the discharge side of the compressor 11 to the evaporator 9 via the condenser 12, the liquid receiver 13 and the expansion valve 14 which composes the decompressing means. The outside air (cooling air) is blown to the condenser 12 by the electrically driven cooling fan 12a.

In the refrigerating cycle unit 10, the compressor 11 is driven by a vehicle engine (not shown) via the electromagnetic clutch 11a. Accordingly, when an electric current sent to the electromagnetic clutch 11a is turned on and off, operation of the compressor 11 can be controlled while being turned on and off. The evaporator 9 cools a flow of air sent from the fan 8 when the gas-liquid two phase refrigerant of low temperature and pressure, which has been decompressed by the expansion valve 14, absorbs the heat from the flow of air and evaporates.

On the other hand, in the interior air conditioning unit 1, on the downstream side of the evaporator 9, the heater core 15 for heating the air flowing in the case 2 is arranged. This heater core 15 is a heat exchanger for heating a flow of air (a flow of cold air), which has passed through the evaporator 9, while the hot water (the engine coolant) of the vehicle engine is used as a heat source. On the side of the heater core 15, the bypass passage 16 is formed. Bypass air of the heater core 15 flows in this bypass passage 16.

Between the evaporator 9 and the heater core 15, the air mixing door 17, which is a temperature adjusting means, is pivotally arranged. This air mixing door 17 is driven by the servo motor 18, so that the rotational position (degree of opening) of the air mixing door 17 can be continuously adjusted.

By the degree of opening of this air mixing door 17, a ratio of the volume of air (volume of hot air) passing through the heater core 15 to the volume of air (volume of cold air) passing through the bypass passage 16 bypassing the heater core 15 is adjusted, so that the temperature of air blowing into the vehicle passenger compartment can be adjusted.

In the most downstream portion of the air passage of the case 2, three types of blowing ports are provided. They are a defroster blowing port 19 for blowing a flow of conditioned air to the windshield W of a vehicle, a face blowing port 20 for blowing a flow of conditioned air to the face of the passenger and a foot blowing port 21 for blowing a flow of conditioned air to the feet of the passenger.

The defroster door 22, the face door 23 and the foot door 24 are pivotally arranged in the upstream portion of these blowing ports 19 to 21. These doors 22 to 24 are opened and closed by the common servo motor 25 via the link mechanism not shown.

Next, the electric control section of this embodiment will be briefly explained as follows. The air conditioning control unit 29 includes: an well-known microcomputer having CPU, ROM and RAM; and a peripheral circuit of the microcomputer. The air conditioning control unit 29 stores a control program for controlling air-conditioning in ROM and conducts various calculation and processing according to this control program.

Sensor detection signals are inputted from a group of sensors 30 to 35 onto the input side of the air conditioning control unit 29. Further, various operation signals are inputted from the air conditioning panel 36, which is arranged close to the instrument panel (not shown) in the front portion of the vehicle passenger compartment, onto the input side of the air conditioning control unit. 29.

Specifically, the group of sensors include: a vehicle speed sensor 30 for detecting the vehicle speed SPD; an outside air sensor 31 for detecting the outside air temperature (temperature outside the vehicle passenger compartment) Tₐₘ; an inside air sensor 32 for detecting the inside air temperature (temperature inside the vehicle passenger compartment) Tᵣ; a sunshine sensor 33 for detecting the amount of sunshine Tₛ incident into the vehicle passenger compartment; an evaporator temperature sensor 34 for detecting the evaporator blowing air temperature Tₑ, arranged in the air blowing portion of the evaporator 9; and a water temperature sensor 35 for detecting the hot water (engine coolant) temperature T_{w} flowing into the heater core 15.

Various well-known operation switches (not shown) are provided on the air conditioning panel 36. Specifically, these various operation switches include: a temperature setting switch for setting a temperature in the vehicle passenger compartment; a blowing mode switch for manually setting various blowing modes which are set by the blowing mode doors 22 to 24; an inside and outside air change-over switch for manually setting the inside air mode and the outside air mode which are changed over by the inside and outside air change-over door 6; an air conditioning switch for sending an operation command signal of the compressor 11; a fan operation switch for sending a signal for manually changing over the amount of air of the fan 8; an automatic switch for sending a command signal of the air conditioning automatic control state; and an off-switch for sending a stop signal of the air conditioning automatic control state.

The output side of the air conditioning control unit is connected with the electromagnetic clutch 11a of the compressor 22, servo motors 7, 18, 25 which are electric drive means for driving various devices, the motor 8b of the fan 8, and the motor 12b of the condenser cooling fan 12a. Operation of these devices is controlled by the output signals sent from the air conditioning control unit 29.

Operation of this embodiment composed as described above will be explained below. First of all, operation of the interior air conditioning unit 1 will be briefly explained as follows. When the fan 8 is operated, air is introduced from the inside air introducing port 3 or the outside air introducing port 4 and blown, in the case 2, toward the vehicle passenger compartment. The electromagnetic clutch 11a is energized so as to connect the electromagnetic clutch 11a, and the compressor 11 is driven by a vehicle engine. In this way, the refrigerant is circulated in the refrigerating cycle device 10.

A flow of air blown from the fan 8 is made to flow through the evaporator 9 and is then cooled and dehumidified. The flow of cooled air is divided into a flow of air flowing in the heater core 15 and a flow of air passing through the bypass passage 16 according to the rotational position (degree of opening) of the air mixing door 17. The flow of air flowing in the heater core 15 is heated by the heater and changed into a flow of hot air, and the flow of air passing through the bypass passage 16 is maintained as a flow of cold air.

Accordingly, when a ratio of the volume of air (volume of hot air) passing through the heater core 15 to the volume of air (volume of cold air) passing through the bypass passage 16 is adjusted by the degree of opening of the air mixing door 17, the temperature of a flow of air blowing into the vehicle passenger compartment can be adjusted. The flow of conditioned air, the temperature of which has been adjusted, is blown from one of the defroster blowing port 19, the face blowing port 20 and the foot blowing port 21 which are located in the most downstream portion of the air passage in the case 2. Alternatively, the flow of conditioned air, the temperature of which has been adjusted, is blown from a plurality of blowing ports of the defroster blowing port 19, the face blowing port 20 and the foot blowing port 21. In this way, the vehicle passenger compartment can be air-conditioned, and the windshield W can be prevented from misting.

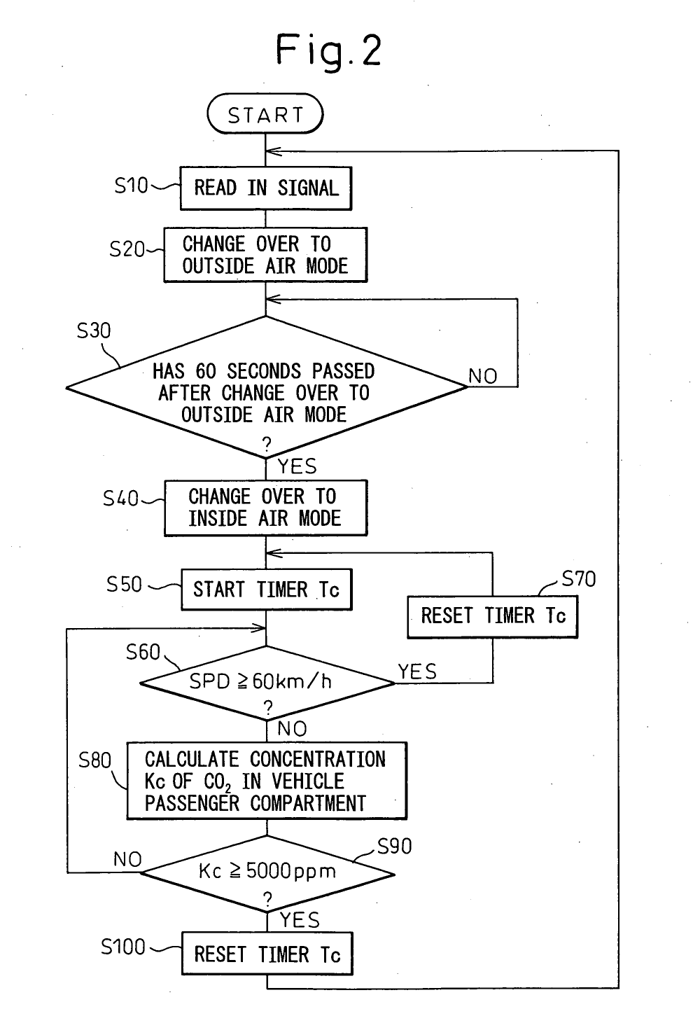

Next, referring to FIG. 2, explanations will be made into automatic control of controlling the change-over between the inside air and the outside air of this embodiment. FIG. 2 is a flow chart of the control routine executed by the microcomputer of the air conditioner control unit 29. This control routine is started when the automatic switch on the air conditioning panel 36 is turned on. In this control routine, first of all, detection signals of the group of sensors 30 to 35 and various operation signals sent from the air conditioning panel 36 are read in step S10.

Next, in step S20, the air suction mode (the inside and outside air suction mode) is changed over to the outside air mode. The reason why the air suction mode is first changed over to the outside air mode is that the vehicle passenger compartment is first ventilated while consideration is being given to the case in which the inside air mode is manually set before the start of automatic control shown in FIG. 2. In this connection, in order to change over to the outside air mode, the servo motor 7 is rotated to a predetermined operational angle position so that the inside and outside air changeover door 6 can be set at the fully open position (the fully closed position of the inside air introducing port 3) of the outside air introducing port 4.

Next, in step S30, it is judged whether or not the elapsed time after the change-over to the outside air mode is a predetermined period of time (60 seconds in this embodiment). When the elapsed time after the change-over to the outside air mode is shorter than the predetermined period of time, step S30 is maintained and the outside air mode is continued.

When the elapsed time of the outside air mode has reached the predetermined period of time, it can be judged that the vehicle passenger compartment has been sufficiently ventilated to a comfortable level for the passenger by executing the outside air mode. Therefore, the program proceeds to the next step S40, and the mode is changed over to the inside air mode. Specifically, the servo motor 7 is rotated to a predetermined operational angle position, so that the inside and outside air change-over door 6 can be operated to the fully open position (the fully closed position of the outside air introducing port 4) of the inside air introducing port 3.

In the next step S50, the timer T_{c}, which is used for measuring the elapsed time after the mode has been changed over to the inside air mode, is started. In the next step S60, it is judged whether or not the vehicle speed SPD is not less than a predetermined value for example, 60 km/h.

This predetermined value (the vehicle speed judging value) is set at a value by which the concentration of CO₂ in the vehicle passenger compartment can be suppressed to a level so that the passenger does not feel uncomfortable. That is, even at the time of the inside air mode, the vehicle passenger compartment can be ventilated when the outside air flows into the vehicle passenger compartment through a gap formed in each portion of the vehicle body and through a gap in the door seal of the outside air introducing port 4. Further, the vehicle passenger compartment can be ventilated when the outside air flows into the vehicle passenger compartment from the drain hose of the air conditioner unit. At the time of the inside air mode, the vehicle passenger compartment is ventilated by dynamic pressure (ram pressure) of vehicle running, that is, the vehicle passenger compartment is naturally ventilated. Accordingly, the amount of ventilation air is increased according to a rise in the vehicle speed. Therefore, even at the time of the inside air mode, when the vehicle is running at a high speed not less than a predetermined speed, the concentration of CO₂ can be suppressed at a value by which the passenger does not feel uncomfortable.

Therefore, when the vehicle speed SPD is not less than a predetermined value, the program proceeds to step S70 and the timer T_{c} is reset, and the program returns to step S50. Accordingly, when the vehicle speed SPD is not less than the predetermined value, the inside air mode is continued.

On the other hand, when the vehicle speed SPD is lower than the predetermined value, the program proceeds to step S80, and the concentration of CO₂ in the vehicle passenger compartment at the time of the inside air mode is calculated. In this case, the concentration of CO₂ in the vehicle passenger compartment essentially depends upon the amount of CO₂ generated by the passenger and the amount of ventilated air in the vehicle passenger compartment at the time of the inside air mode (the amount of air naturally ventilated).

The amount of CO₂ generated by passengers can be expressed by the product of the amount of generated CO₂ per one passenger and the number of the passengers. On the other hand, the amount of ventilated air in the vehicle passenger compartment at the time of the inside air mode can be found according to the vehicle speed for the reasons described above. Specifically, the amount of ventilated air in the vehicle passenger compartment can be found by the product of the amount of ventilated air per unit vehicle speed, which is set for each vehicle, and the actual vehicle speed.

When consideration is given to the elapsed time after the change-over to the inside air mode and the concentration of CO₂ in the outside air, it is possible to find the amount of CO₂ in the vehicle passenger compartment at a predetermined time after the mode has been changed over to the inside air mode. Further, when consideration is given to the volume inside the vehicle passenger compartment, the concentration of CO₂ in the vehicle passenger compartment can be calculated.

According to the above, the concentration K_{c} of CO₂ in the vehicle passenger compartment at the time of inside air mode can be calculated by the following expression 1.

$$Kc = \{ ( 1 - {ⅇ}^{\frac{- v * SPD * Tc}{A}} ) \frac{m * Y}{v * SPD} \} * \frac{{10}^{6}}{A} + Ko \qquad ( Expression 1 )$$

where

T_{c}: Elapsed time (h) after the change-over to the inside air mode

SPD: Vehicle speed (km/h)

v: Amount of ventilated air per 1 km/h of vehicle speed at the time of the inside air mode (m³/h)

A: Volume inside the vehicle passenger compartment (m³)

m: Volume of air generated by one passenger per unit time (m³/(h·man)

Y: Number of passengers (man)

Kₒ: Concentration of CO₂ of outside air (ppm)

K_{c}: Concentration of CO₂ in the vehicle passenger compartment at the point of time when predetermined time T_{c} has passed after the mode was changed over to the inside air mode

In this connection, in Expression 1, the amount of ventilated air v and the volume A inside the vehicle passenger compartment can be the fixed values which are set for each vehicle. For example, in the case of a sedan type car, the fixed values can be previously set in such a manner that the volume of ventilated air v=0.22 m³/h and the volume inside the vehicle passenger compartment A=2 m³.

Concerning the amount m of generated CO₂, it is possible to previously set a value, which is generally recognized to be used at the time of very light work, for example, it is possible to previously set a fixed value of 0.022 (m³/h·man). Concerning the number Y of passengers, while consideration is being given to the worst condition of generation of CO₂ , it is possible to previously set the fixed value of 5 which is the maximum number of passengers of a usual car.

Concerning the concentration of CO₂ in the outside air, the representative value in the common vehicle running condition can be previously set, for example, the fixed value 300 ppm can be previously set.

When the fixed values exemplarily shown above are applied to each item of Expression 1, the concentration K_{c} of CO₂ in the vehicle passenger compartment at the time of the inside air mode can be calculated by the following Expression 2.

$$Kc = ( \frac{1 - {ⅇ}^{- 0.0025 * SPD * Tc}}{SPD} ) * 5 * {10}^{5} + 300 \qquad ( Expression 2 )$$

Specifically, in step S80, the concentration K_{c} of CO₂ in the vehicle passenger compartment is calculated by this Expression 2. According to this Expression 2, only the elapsed time T_{c} after the change-over to the inside air mode and the vehicle speed SPD may be reflected as variables on the concentration K_{c} of CO₂ in the vehicle passenger compartment, and all other elements may be previously set as the fixed values. Accordingly, concerning the sensor detection value, only the detection value of the vehicle speed sensor 30 may be inputted. Therefore, the electrical control system can be simplified.

In the next step S90, it is judged whether or not the calculated value of the concentration K_{c} of CO₂ in the vehicle passenger compartment is higher than a predetermined value. This predetermined value is a value at which the passenger in the vehicle passenger compartment feels uncomfortable because the concentration of CO₂ in the vehicle passenger compartment is high. For example, this predetermined value is 5000 ppm. When the concentration K_{c} of CO₂ in the vehicle passenger compartment is lower than the predetermined value, the passenger in the vehicle feels comfortable. Therefore, the program returns from step S90 to step S60, so that the state of the inside air mode can be maintained.

On the other hand, when the concentration K_{c} of CO₂ in the vehicle passenger compartment is raised to a value not less than the predetermined value, the program proceeds to step S100, and the timer T_{c} is reset. After that, the program proceeds to steps S10 and S20. In step S20, the mode is changed over to the outside air mode. Due to the foregoing, the amount of ventilated air in the vehicle passenger compartment can be rapidly increased as compared with the inside air mode. Therefore, the concentration of CO₂ in the vehicle passenger compartment can be rapidly reduced.

As the outside air mode can be continued until the judgment YES is made in step S30, it is possible to sufficiently reduce the concentration of CO₂ in the vehicle passenger compartment so that the passenger does feel comfortable. Accordingly, the passenger does not feel uncomfortable because the concentration of CO₂ in the vehicle passenger compartment is not raised to an uncomfortable level. Therefore, the passenger can comfortably ride in the vehicle.

Further, as the inside air mode can be maintained when the vehicle speed SPD is not less than a predetermined value (60 km/h) and the concentration K_{c} of CO₂ in the vehicle passenger compartment is lower than a predetermined value, it is possible to raise a ratio of the inside air mode at the time of operation of air-conditioning. At the time of the inside air mode, the vehicle passenger compartment can be air-conditioned by circulating the vehicle passenger compartment air again, the temperature of which has been adjusted. Therefore, not only the heat load of air-conditioning can be reduced but also the polluted outside air can be prevented from flowing into the vehicle passenger compartment and further the vehicle passenger compartment air can be prevented from becoming dry when the temperature is low in winter.

Next, the corresponding relation of the first embodiment with the function realizing means of the present invention will be described below. In step S80 shown in FIG. 2, the vehicle passenger compartment CO₂ concentration calculating means of the present invention is composed. In steps S90 and S20 shown in FIG. 2, the outside air mode change-over control means of the present invention is composed.

Next, a second embodiment will be explained below. In the first embodiment, the actual detection value of the vehicle speed sensor 30 is used as the vehicle speed SPD (km/h) as it is. However, in the second embodiment, the vehicle speed SPD, which is calculated by the following expression 3 when the actual vehicle speed is smoothed (averaged), is used as the vehicle speed SPD, and the judgment is made in step S60 and the concentration of CO₂ is calculated in step S80.

$$SPD60 ( t ) = \frac{59 * SPD60 ( t - 1 ) + SPD ( t )}{60} \qquad ( Expression 3 )$$

According to Expression 3, the smoothed vehicle speed SPD60(t) at the predetermined time t (unit: second) after the change-over to the inside air mode is calculated in the case where the actual vehicle speed detected by the vehicle speed sensor 30 is read every one second. In this connection, “60” in SPD60(t) represents 60 seconds of the denominator of Expression 3. SPD60(t−1) in Expression 3 represents the smoothed vehicle speed calculated before. SPD(t) represents an actual vehicle speed at the predetermined calculation time t.

The calculation of the smoothed vehicle speed SPD60 by Expression 3 is a smoothing (averaging) process in which the smoothed vehicle speed SPD60(t−1) calculated last time is weighed by 59 times with respect to the actual vehicle speed SPD(t) at the calculation time t. This smoothing process can be said to be smoothing process conducted with a time constant 60 seconds.

When the thus smoothed SPD60 is used as a vehicle speed value in steps S60 and S80, it is possible to prevent the result of judgment in step S60 and the CO₂ concentration calculation value in step S80 from frequently changing by a temporary sudden change in the vehicle speed. Accordingly, the inside and outside air change-over control can be stably executed.

Next, a third embodiment will be explained below. In the first embodiment, in the expression to calculate the concentration of CO₂ in step S80, when the number of passengers is represented by the reference sign Y, the fixed value 5, which is the maximum number of passengers in an ordinary car, is previously set. However, in the third embodiment, the number Y of passengers is detected by a passenger detection sensor, and the concentration of CO₂ is calculated according to the number Y of passengers actually detected. That is, the concentration of CO₂ is calculated when the number Y of passengers is dealt with as a variable.

In this connection, concerning the passenger detection sensor, it is possible to use a seat switch which is turned on when a passenger sits down in the seat. Alternatively, it is possible to use an infrared rays sensor capable of detecting the surface temperature of a passenger without coming into contact with the passenger.

When a passenger number inputting device capable of manually inputting the number Y of passengers is provided on the air-conditioning panel 36 instead of the passenger detection sensor and this passenger number inputting device is manually operated, the actual number Y of passengers may be reflected on the calculation of the concentration of CO₂.

According to the third embodiment, it is possible to accurately grasp the amount of generated CO₂. Therefore, the accuracy of calculating the concentration of CO₂ can be enhanced.

Next, a fourth embodiment will be explained below. In the first embodiment, according to the elapsed time after the mode was changed over to the outside air mode, it is judged that the concentration of CO₂ in the vehicle passenger compartment is reduced to a comfortable level for passengers by increasing the amount of ventilated air in the vehicle passenger compartment by the outside air mode (step S30 in FIG. 2). However, in the fourth embodiment, operation may be conducted as follows. Instead of using the elapsed time after the mode was changed over to the outside air mode, the concentration of CO₂ in the vehicle passenger compartment is calculated at the time of the outside air mode. When the thus calculated concentration of CO₂ in the vehicle passenger compartment is decreased to a predetermined value, the program proceeds to step S40 and the mode may be changed over to the inside air mode.

In this connection, the concentration of CO₂ in the vehicle passenger compartment at the time of the outside air mode can be calculated in the same manner as that of Expressions 1 and 2 described before. That is, in Expression 1, when the volume v (m³/h) of ventilated air per 1 km/h of the vehicle speed at the time of the inside air mode is replaced with the volume v′ (m³/h) of ventilated air per 1 km/h of the vehicle speed at the time of the outside air mode, the concentration of CO₂ in the vehicle passenger compartment at the time of the outside air mode can be calculated in the same manner. In this connection, of course, the relation v<v′ can be established.

Finally, another embodiment will be explained below. In this connection, in the first embodiment, in Expression 1 for calculating the concentration K_{c} of CO₂ in the vehicle passenger compartment at the time of the inside air mode, the term of the concentration Kₒ of CO₂ of the outside air is provided. However, the term of the concentration Kₒ of CO₂ of the outside air is eliminated. Instead of that, a correction may be made so that the amount of ventilated air in the vehicle passenger compartment at the time of the inside air mode (the product of the amount v of ventilated air per unit vehicle speed and the vehicle speed SPD) can be decreased by the amount corresponding to the concentration Kₒ of CO₂ of the outside air.

As a predetermined correlation can be established between the vehicle speed and the engine speed of the vehicle, instead of the vehicle speed, the engine speed of the vehicle may be detected, and thus detected engine speed of the vehicle may be used as an information value relating to the vehicle speed.

In step S20 shown in FIG. 2, it is explained that the mode is changed over to the outside air mode in which the ventilated air is the outside air by 100%. However, corresponding to the environmental condition of the vehicle and the thermal load condition of air-conditioning, the outside air mode, in which the inside air is partially mixed with the outside air, may be set in step S20 shown in FIG. 2.

In the same manner, the inside air mode in step S40 shown in FIG. 2 may be the inside air mode in which the outside air is partially mixed with the inside air.

While the invention has been described by reference to specific embodiments chosen for purposes of illustration, it should be apparent that numerous modifications could be made thereto, by those skilled in the art, without departing from the basic concept and scope of the invention.

1. An inside and outside air change-over control unit for vehicle use comprising:
an inside and outside air change-over means (6) for changing over between an inside air mode to introduce the inside air from a vehicle passenger compartment and an outside air mode to introduce the outside air from the outside of the vehicle passenger compartment, the introduced inside air or outside air being introduced to a blowing port to the vehicle passenger compartment; and
a control unit (29) for controlling an operational position of the inside and outside air change-over means (6),
the control unit (29) including:
a calculation means (S80) for calculating the concentration of CO₂ in the vehicle passenger compartment at the time of the inside air mode; and
a change-over control means (S20, S90) for changing over the inside and outside air change-over means (6) to the outside air mode when the calculated concentration of CO₂ in the vehicle passenger compartment exceeds a predetermined value, wherein
the calculation means (S80) calculates the concentration of CO₂ in the vehicle passenger compartment at the time of the inside air mode according to the elapsed time, which is a variable, after the change-over to the inside air mode and also according to the amount of ventilated air in the vehicle passenger compartment, which is a variable, generated by dynamic pressure of vehicle running at the time of the inside air mode.

2. An inside and outside air change-over control unit for vehicle use according to claim 1, wherein the calculation means (S80) calculates the concentration of CO₂ in the vehicle passenger compartment at the time of the inside air mode according to the elements including the amount of CO₂ generated by a passenger at the time of the inside air mode, an elapsed time after the change-over to the inside air mode, the amount of ventilated air generated by dynamic pressure of vehicle running at the time of the inside air mode and a volume inside the vehicle passenger compartment.

3. An inside and outside air change-over control unit for vehicle use according to claim 2, wherein the amount of ventilated air in the vehicle passenger compartment is calculated from an information value relating to a vehicle speed, which is a variable, and
the calculation means (S80) calculates the concentration of CO₂ in the vehicle passenger compartment at the time of the inside air mode when the elapsed time after the change-over to the inside air mode and the amount of ventilated air in the vehicle passenger compartment are used as variables and the fixed values, which have been previously set, are used for the other elements.

4. An inside and outside air change-over control unit for vehicle use according to claim 2, wherein the amount of ventilated air in the vehicle passenger compartment is calculated from the information value relating to the vehicle speed, including variables, the amount of CO₂ generated by passengers at the time of the inside air mode is calculated from the number of passengers, which is a variable, and
the calculating means (S80) only includes the variables of the elapsed time after the change-over to the inside air mode, the amount of ventilated air in the vehicle passenger compartment and the amount of CO₂ generated by passengers at the time of the inside air mode and also includes the previously determined fixed values of the other elements so as to calculate the concentration of CO₂ in the vehicle passenger compartment at the time of the inside air mode.

5. An inside and outside air change-over control unit for vehicle use according to claim 3, further comprising a sensor (30) for detecting an information value relating to the vehicle speed, wherein a value obtained after the detection value of the sensor (30) has been smoothed is used for calculating the amount of ventilated air in the vehicle passenger compartment as the information value relating to the vehicle speed.

6. An inside and outside air change-over control unit for vehicle use according to claim 3, wherein the information value relating to the vehicle speed is a vehicle speed or an engine speed of the vehicle.

7. An inside and outside air change-over control unit for vehicle use according to claim 3, wherein when the information value relating to the vehicle speed is not less than a predetermined value, the inside air mode is maintained.

8. An inside and outside air change-over control unit for vehicle use according to claim 7, wherein when the information value relating to the vehicle speed is not less than a predetermined value, the calculation of the concentration of CO₂ in the vehicle passenger compartment conducted by the calculation means is stopped and the inside air mode is maintained.

9. An inside and outside air change-over control unit for vehicle use according to claim 1, further comprising a fan and a heat exchanger arranged between the inside and outside air change-over means (6) and the blowing port, wherein a flow of air, the temperature of which is adjusted when it has passed through the heat exchanger (9, 15), is blown into the vehicle passenger compartment via the blowing port.

10. An inside and outside air change-over control unit for vehicle use according to claim 1, further comprising an automatic switch for outputting an operational signal to automatically control the inside and outside air change-over means into the control unit,
the control unit (29) including a means in which, when the automatic switch is turned on, the inside and outside air change-over means is changed over to the outside air mode, it is judged whether or not the elapsed time after the change-over to the outside air mode has passed through a predetermined time, the outside air mode is continued when the elapsed time after the change-over to the outside air mode does not exceed a predetermined period of time, and the control for changing over the outside air mode to the inside air mode is executed as an initial mode when the elapsed time has reached a predetermined period of time.

11. An inside and outside air change-over control unit for vehicle use according to claim 10, further comprising:
a timer means for measuring the elapsed time of the inside air mode after the automatic switch has been turned on, arranged in the control unit; and a means for judging whether or not the information value relating to the vehicle speed is not less than a predetermined value, wherein
when the judging means judges that the information value is an information value relating to the vehicle speed not less than the predetermined value, the measurement of time by the timer means is reset, and when the information value relating to the vehicle speed is lower than the predetermined value, the calculation means calculates the concentration of CO₂ at the time of the inside air mode according to the elapsed time measured by the timer means and also according to the amount of ventilated air in the vehicle passenger compartment, which is a variable, generated by dynamic pressure of running vehicle at the time of the inside air mode.

12. An inside and outside air change-over control unit for vehicle use according to claim 10, wherein the calculation means calculates the concentration of CO₂ in the vehicle passenger compartment at the time of inside air mode in such a manner that while consideration is being given to the amount of CO₂ generated by passengers, the amount of CO₂ generated by the passengers is found from the product of the amount of CO₂ generated by one passenger and the number of the passengers, and the amount of ventilated air in the vehicle passenger compartment is found according to the Information value relating to the vehicle speed.

13. An inside and outside air change-over control unit for vehicle use according to claim 12, wherein the amount of ventilated air in the vehicle passenger compartment is found by the product of the amount of ventilated air per unit vehicle speed, which is set for each vehicle, and the vehicle speed.

14. An inside and outside air change-over control unit for vehicle use according to claim 10, wherein the concentration of CO₂ in the vehicle passenger compartment at the point of time when the predetermined period of time has passed after the change-over to the inside air mode is calculated as a function, the variables of which are at least the amount of ventilated air per unit vehicle speed at the time of the inside air mode, the vehicle speed of the vehicle, the elapsed time after the change-over to the inside air mode, the volume in the vehicle passenger compartment, the amount of generated CO₂ per one passenger and unit time, the number of passengers and the concentration of CO₂ of the outside air.

15. An inside and outside air change-over control unit for vehicle use according to claim 14, wherein the amount of ventilated air per unit vehicle speed at the time of the inside air mode, the volume in the vehicle passenger compartment, the amount of generated CO₂ per one passenger and unit time, the number of passengers and the concentration of CO₂ of the outside air are the fixed values which have been previously set, and the vehicle speed of the vehicle and the elapsed time after the change-over to the inside air mode include variables.

16. An inside and outside air change-over control unit for vehicle use according to claim 10, wherein
a predetermined value is set as a value of the level at which a passenger in the vehicle passenger compartment feels uncomfortable due to an increase in the concentration of CO₂,
the inside and outside air change-over control unit for vehicle use further comprises a means for judging whether or not the concentration of CO₂ in the vehicle passenger compartment at the time of the inside air mode calculated after the change-over to the inside air mode is not less than the above predetermined value, and
when the concentration of CO₂ in the vehicle passenger compartment is lower than the predetermined value, the state of inside air mode is maintained, and when the concentration of CO₂ in the vehicle passenger compartment is not less than the predetermined value, the inside air mode is changed over to the outside air mode, and the outside air mode is continued until a predetermined condition is established.

17. An inside and outside air change-over control unit for vehicle use according to claim 16, wherein the establishment of the predetermined condition is that a predetermined period of time has passed after the change-over to the outside air mode or that the concentration of CO₂ in the vehicle passenger compartment calculated after the change-over to the outside air mode has decreased to a predetermined level, and the outside air mode is changed over to the inside air mode after the establishment of the predetermined condition.

18. An inside and outside air change-over control unit for vehicle use according to claim 17, wherein the concentration of CO₂ in the vehicle passenger compartment calculated after the change-over to the outside air mode is calculated as a function, the variables of which are at least the vehicle speed of the vehicle and the elapsed time after the change-over to the outside air mode.

19. An inside and outside air change-over control unit for vehicle use according to claim 18, wherein the concentration of CO₂ in the vehicle passenger compartment calculated after the change-over to the outside air mode is calculated as a function, the variables of which are the amount of ventilated air per unit vehicle speed at the time of the outside air mode, the vehicle speed of the vehicle, the elapsed time after the change-over to the outside air mode, the volume in the vehicle passenger compartment, the amount of generated CO₂ per one passenger and unit time, the number of passengers and the concentration of CO₂ of the outside air.

20. An inside and outside air change-over control unit for vehicle use according to claim 19, wherein the amount of ventilated air per unit vehicle speed at the time of the outside air mode, the volume in the vehicle passenger compartment, the amount of generated CO₂ per one passenger and unit time, the number of passengers and the concentration of CO₂ of the outside air are the fixed value which have been previously set, and the vehicle speed of the vehicle and the elapsed time after the change-over to the outside air mode include variables.
